(19) United States
(12) Patent Application Publication
(10) Pub. No.: US 2021/0219012 A1
(43) Pub. Date: Jul. 15, 2021

(54) SYSTEM AND A COMPUTERIZED METHOD FOR AUDIO LIP SYNCHRONIZATION OF VIDEO CONTENT

(71) Applicant: IChannel.IO Ltd., Petah Tikva (IL)

(72) Inventor: Oren Jack MAURICE, Yoqneam Moshava (IL)

(73) Assignee: IChannel.IO Ltd., Petah Tikva (IL)

(21) Appl. No.: 17/200,450

(22) Filed: Mar. 12, 2021

Related U.S. Application Data
(63) Continuation of application No. PCT/IL2019/051022, filed on Sep. 12, 2019.
(60) Provisional application No. 62/730,555, filed on Sep. 13, 2018.

(51) Int. Cl. H04N 21/43; H04N 21/242; H04N 21/439; H04N 21/44

(52) U.S. Cl. CPC H04N 21/4307; H04N 21/44008; H04N 21/4394; H04N 21/242

(57) ABSTRACT

Audiovisual content in the form of video clip files, streamed or broadcasted may present a problem known as a lip sync error, i.e., the motion of the lips of a speaker do not correspond to the sound at the same time. So as to overcome the problem the video content to the system the video content is segmented according to video scene cuts. Similarly, the audio is segmented at audio scene cuts. Analyzer compares the timing of the various cuts and determines if a lip sync error has occurred and if so if the system can provide a correction to overcome the problem. When a lip sync error is detected, based on a comparison between the video scene cuts and the audio scene cuts, a correction may be either suggested or automatically applied.

### CROSS-REFERENCE TO RELATED APPLICATIONS

This application is a continuation of a PCT Application No. PCT/IL2019/051022 filed Sep. 12, 2019 claims the benefit of U.S. Provisional Application No. 62/730,555 filed on Sep. 13, 2018, the contents of which are hereby incorporated by reference.

### TECHNICAL FIELD

The disclosure relates to lip synchronization (lip sync) between a video signal and its respective audio signal, and in particular to the correction of lip sync errors between the video signal and the audio signal.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

Lip synchronization error, also referred to as lip sync error, is defined as when the timing of a video portion deviates from the timing of its respective audio portion. Such a mismatch between the video signal and the audio signal, especially when the mismatch is above a certain threshold, is bothersome to the viewers and considered to be of poor quality. Unless care is taken to maintain the audio and video in sync this phenomena may continue and even become worse as transmission continues. The timing differential, which may be static or dynamic, is typically referred to as the lip sync error. That is, the visual effect of the motion of a speaker's lips is out of sync (i.e., not synchronized) with the audio heard. This requirement for lip synchronization may occur in broadcast and live streaming as well as video clip transmission from files.

The prior art teaches a variety of ways to reduce the lip sync error. One method calls for manual adjustment of the lip sync error based on an observation made by a user of a control system. Once the observer detects a lip sync error a manual adjustment, for example, delaying the video or delaying the audio, resolves the lip sync error. This method has many drawbacks including its subjectivity, i.e., it is dependent on a particular user's experience rather than on an objective metric, it being error prone, and it being difficult to scale as the number of video channels exponentially increase over time. This may also be achieved automatically if a previously detected delay is known and a delay factor is automatically used. This method is deficient as this requires the use of typically an arbitrary delay factor that may or may not be suitable for a particular case. Moreover, it does not resolve any dynamic changes in the lip sync error that may occur during the delivery of a video clip to a client. Yet other prior art methods for detection of lip sync errors include the insertion of a video signal in sync with an audio synchronization signal, also referred to as a “pip”. This allows for occasional synchronization between the video signal and the audio signal at rendezvous points. Yet another type of solution attempts to analyze the lip motion from its visual clues and correlate them to the audio provided by the audio track. One of ordinary skill in the art would readily appreciate that these methods require specialized and mostly expensive equipment. The exponential growth of video delivery and the need to reduce costs significantly cannot be supported by such prior methods.

It is therefore desirable to provide a solution that will allow for affordable, simple and real-time lip sync to support the ever increasing demand to resolve the lip sync error problem.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a system for lip synchronization of audiovisual content comprises: a video cut analyzer adapted to receive a video portion of the audiovisual content and output video segments at video scene cuts; an audio cut analyzer adapted to receive audio portion of the audiovisual content and output audio segments at audio scene cuts; a video-audio scene delta analyzer adapted to receive the video segments and the audio segments and determine therefrom at least a time delta value between the video segments and the audio segments and determine at least a correction factor; and, a lip sync error correction unit adapted to receive the video segments, the audio segments and the correction factor and output a lip sync corrected audiovisual content, wherein the correction factor is used to reduce the time delta value of the lip sync corrected audiovisual content to below a predetermined threshold value.

Certain embodiments disclosed herein include method for lip synchronization of audiovisual content comprises: receive audiovisual content that require lip sync; detect all video scene cuts in the received video content of the audiovisual content; detect all audio scene cuts in the received audio content of the audiovisual content; perform a comparison analysis between video cuts and audio cuts to determine a sync error; generate a notification that a lip sync is required for the audiovisual content but cannot be performed upon determination that the sync error is not within correctable parameters; generate a notification that no lip sync is required for the audiovisual content upon determination that the lip sync error is within correctable parameters and that an offset between the video content and the audio content is below a predetermined threshold value; and, perform lip sync error correction to reduce the lip sync error between the video content and the audio content upon determination that the lip sync error is within correctable parameters and that the offset between the video content and the audio content exceeds the predetermined threshold value.

### BRIEF DESCRIPTION OF THE DRAWINGS

The foregoing and other objects, features and advantages will become apparent and more readily appreciated from the following detailed description taken in conjunction with the accompanying drawings, in which:

FIG. 1 is a schematic illustration of a system according to an embodiment.

FIG. 2A is a schematic illustration of a first unsynchronized audio and video stream by a time difference according to an embodiment.

FIG. 28 is a schematic illustration of a second unsynchronized audio and video stream by a time difference according to an embodiment.

FIG. 3 is a schematic block diagram of a system for lip sync error correction according to an embodiment.

FIG. 4 is a schematic illustration of a first flowchart for detection and correction of lip sync error according to an embodiment.

FIG. 5 is a schematic illustration of a second flowchart for detection and correction of lip sync error according to an embodiment.

FIG. 6 is a schematic illustration of a third flowchart providing details of the determination of mismatch cost for the second flowchart.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

Audiovisual content in the form of video clip files, streamed or broadcasted may present a problem known as a lip sync error, i.e., the motion of the lips of a speaker do not correspond to the sound at the same time. So as to overcome the problem the video content to the system the video content is segmented according to video scene cuts. Similarly, the audio is segmented at audio scene cuts. Analyzer compares the timing of the various cuts and determines if a lip sync error has occurred and if so if the system can provide a correction to overcome the problem. When a lip sync error is detected, based on a comparison between the video scene cuts and the audio scene cuts, a correction may be either suggested or automatically applied.

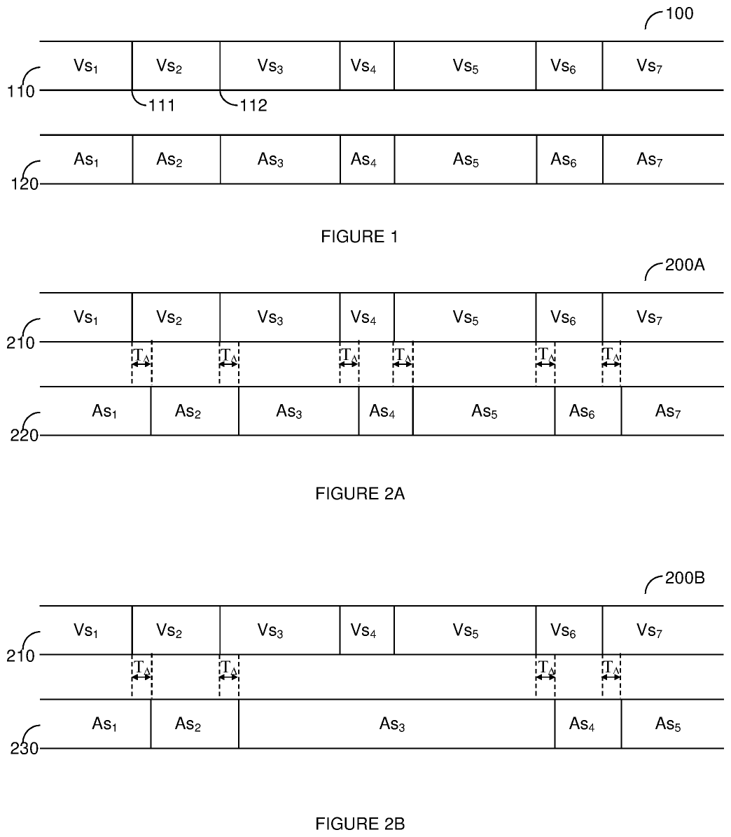

Reference is now made to FIG. 1 where an exemplary and non-limiting schematic illustration 100 of a synchronized audio and video stream is provided. While a reference herein is made to an audiovisual content stream it should be understood that the application of the invention disclosed herein is broader and applies to such content that is streamed, provided from file or otherwise broadcasted. The video stream 110 has various video scenes Vs₁ through Vs₇. According to principles of the invention these video scenes are determined based on analysis of neighboring frames, searching, for example and without limitation, for a sudden spike in the difference between the neighboring frames, or according to any of a plurality of prior art methods including, without limitation, those specified herein. These tend to change from one video scene to another. For example, as a video clip moves from a scene inside a home to a scene on the street a cut, for example cut 111, is determined and another scene begins. That is, in this particular example and without limitation, scene Vs₁ is in a home while scene Vs₂ is in the street, the cut between the scenes being at 111. Then the scene may move into a car, changing the video frames content abruptly and therefore suggesting a scene cut, indicated for example as cut 112. As a result the subsequent scene Vs₃ is a scene happening within a car. A similar process, with obvious adaptations for the different type of media, is performed in order to slice the audio track into segments, looking for abrupt changes in the ambient sound, or according to any of the listed prior art methods. In this exemplary and non-limiting example, the audio stream 120 is perfectly aligned with the video stream 110, that is As₃ and As₅ are in sync with Vs₃ and Vs₅ while As₄ is in sync with Vs₄. A case like this would not require any lip sync correction as no lip sync error actually is shown. The division into the segments Vs₁ through Vs₇ and corresponding As₁ through As₇ are integral to the principles of the inventions though ways of such segmentation of video and/or audio are found in the prior art and are outside the scope of the current invention. One of ordinary skill in the art would readily appreciate that even imperfect alignment between the audio and the video may be tolerable by a user if such is below a predetermined threshold. Typically for the industry a threshold of a misalignment between audio and video that is up to 80 milliseconds is considered to be acceptable and therefore no lip sync error correction may be needed. The invention is concerned of novel and inventive use of such segmentation.

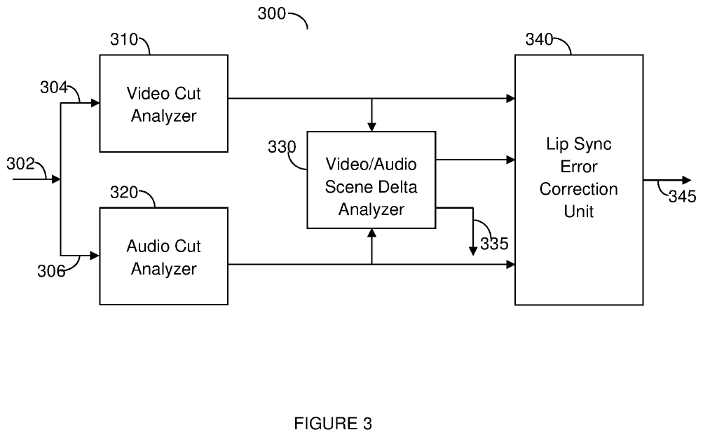

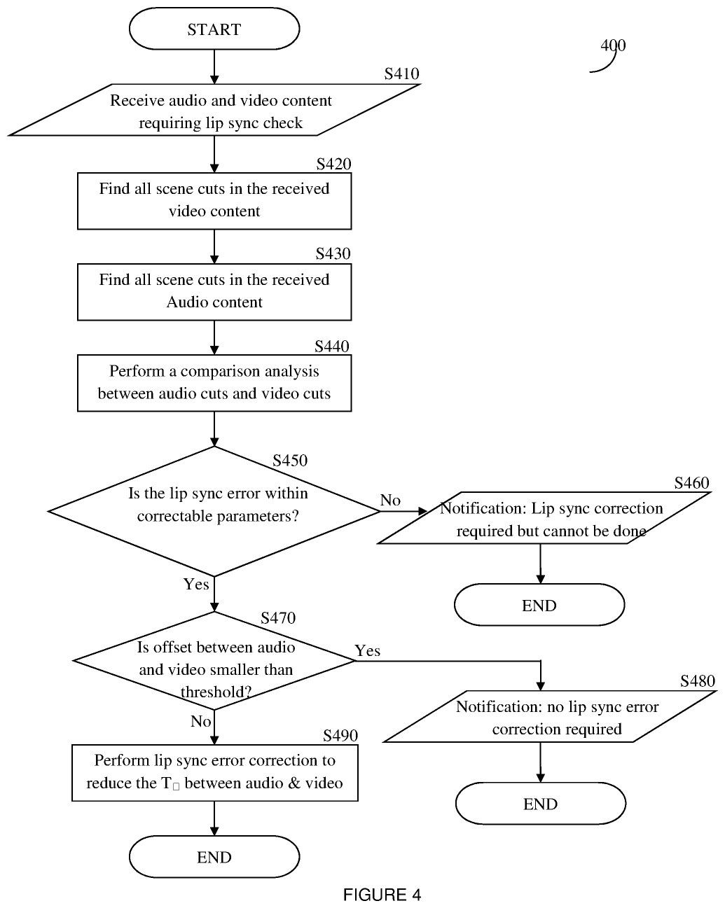

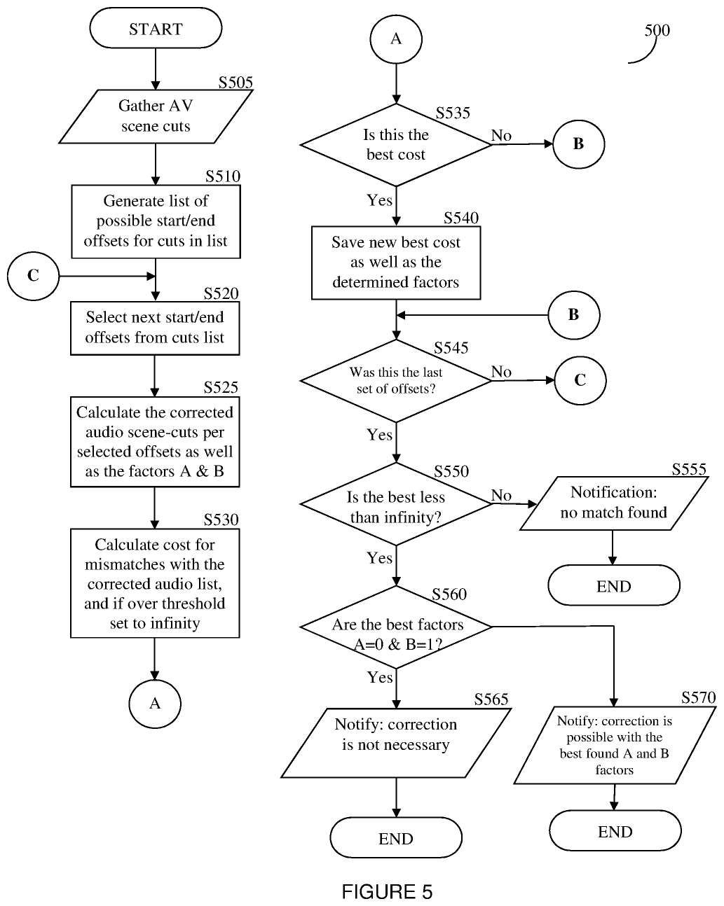

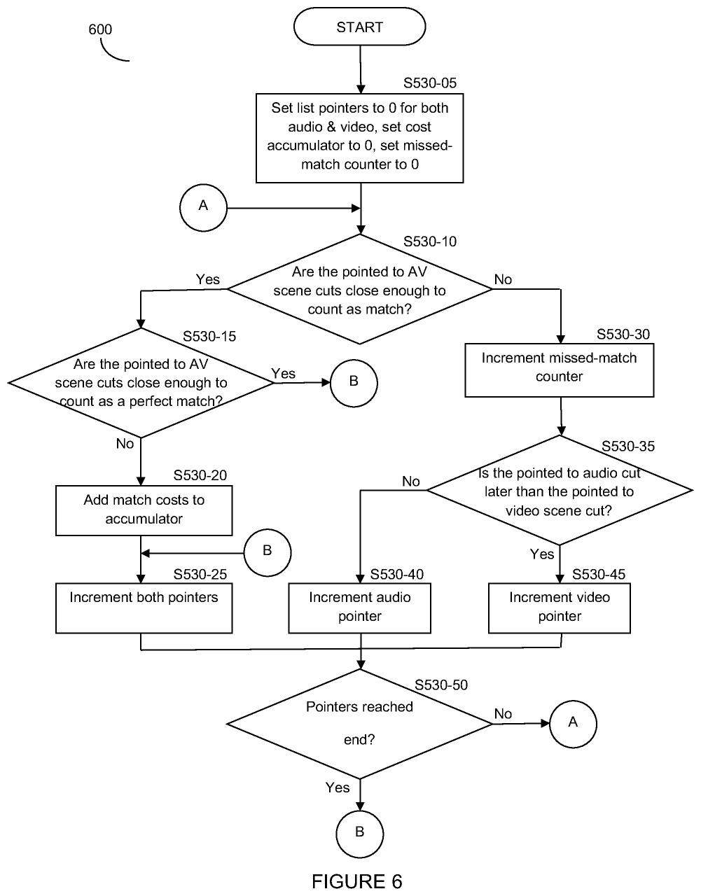

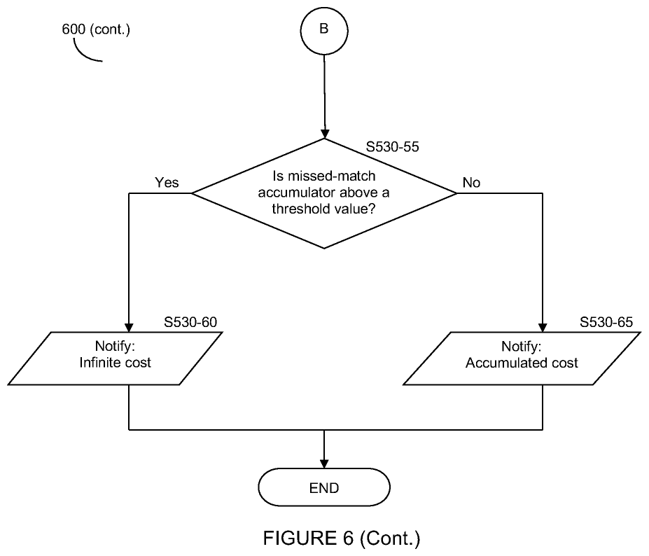

FIG. 2A is an exemplary and non-limiting schematic illustration 200A of a first unsynchronized audio 220 and video stream 210 by a time difference T_{Δ}. As can be seen, the time difference between the video stream 210 and the audio stream is constant for the purpose of this illustration. The value of T_{Δ} may also fluctuate to a certain degree around a threshold value Δ without departing from the scope of the disclosure herein. Therefore, a segmentation of the video stream 210 and the audio stream 220, performed according to the principles of the invention, shows a delta value between the audio and the video, then, if T_{Δ} is above a predetermined threshold value Δ a correction may be either attempted automatically, or, a notification may be generated to alert an operator that an adjustment may be necessary. FIG. 2B is an exemplary and non-limiting schematic illustration 200B second unsynchronized audio and video stream by a time difference. This illustration however differs from that shown in FIG. 2A. While the same video sequence from Vs₁ through Vs₇ is shown, the audio stream is different. For Vs₃ through Vs₅ no audio cut, or segment is found, rather a continuous audio segment As₃ is detected. Thereafter the T_{Δ} values for the lip sync error continue. As will be explained herein a decision may be taken as to the lip sync error correction that may be taken, for example, if this occurs at a low enough frequency throughout the received audiovisual content it may be assumed the a T_{Δ} lip sync correction should take place.

Reference is now made to FIG. 3 which is an exemplary and non-limiting schematic block diagram of a system 300 for lip sync error correction according to an embodiment. An audiovisual content 302 is provided and the video content 304 is directed to a video cut analyzer 310. The video cut analyzer 310 is enabled to segment the video content 304 to a plurality of video segments which are then provided by the video cut analyzer 310 to a video/audio scene delta analyzer 330 as well as to a lip sync error correction unit 340. The video cut analyzer 310 performs the segment cuts based on, for example but not by way of limitation, known in the art segmentation techniques. The audio content 306 of the audiovisual content 302 is provided to an audio cut analyzer. The audio cut analyzer 320 is enabled to segment the audio content 306 to a plurality of audio segments which are then provided by the audio cut analyzer 320 to the video/audio scene delta analyzer 330 as well as to a lip sync error correction unit 340. The audio cut analyzer 320 performs the segment cuts based on, for example but not by way of limitation, detection of changes in ambient noise (or sound) when changing from one scene to another. One out of many prior art solutions for such scene change detection is discussed in Lin et al., “Acoustic Scene Change Detection by Spectro-Temporal Filtering on Spectogram Using Chirps”. Another scene change detection method is provided by Kyperountas et al., in “Enhanced Eigen-Audioframes for Audiovisual Scene Change Detection”. The voice/audio scene delta analyzer (also referred to herein as the delta analyzer) 330 performs an analysis respective of the T_{Δ} values between the video segments, as cut by the video cut analyzer 310, and the audio segments, as cut by the audio cut analyzer 320. Assuming there are a sufficient number of both audio and video segments, the analyzer may provide several types of different notification on notification signal 335. The first notification is that no lip sync errors were detected, which would mean that the T_{Δ} values found are below a predetermined Δ threshold value, or, that the number of cases where the T_{Δ} values exceed the minimum Δ threshold value is below another predetermined threshold value K. In one example, but not by way of limitation, the value of Δ is 60 milliseconds and the value of K is 10%. In such cases no lip sync error correction may be necessary. Both Δ and K threshold values may be programmable so as to allow for tighter or looser threshold values depending on the desired quality of service with respect to lip sync errors. Another case is where it is impossible to make any kind of lip sync error correction and the system 300 provides a notification on signal 335 of this case. Such a case may happen when the lip sync error is above the Δ threshold and has an inconsistent value. The inconsistency may be determined as an inconsistency between Δ value that is above a predetermined E threshold. In this case a notification may be provided on the notification signal 335 to alert an operator of the system 300 that certain manual intervention may be required as automatic lip sync error correction cannot be performed by the system 300.

In between these two cases there are two other cases that may be handled according to the principles of the invention. The first case is when the T_{Δ} is of a consistent value above Δ but below a predetermined E error value. The second case is when T_{Δ} is of a consistently increasing or decreasing value above Δ but below a predetermined E error value. In both cases lip sync error correction takes place and is correctable. Such error correction is performed by the lip sync error correction unit 340 that receives the video segments from the video cut analyzer 310 and the audio segments from the audio cut analyzer 320 as well as any necessary information regarding the analysis performed by the video/audio scene delta analyzer 330. Hence if the video/audio scene delta analyzer 330 has concluded that the T_{Δ} value is below the predetermined E threshold value then the correction is possible. A correction factor is used by the lip sync error correction unit 340 to compensate for the T_{Δ} value. If the distribution around the T_{Δ} value is small, then correction can be made, however, if the distribution is large, i.e., it is inconsistent, then it is not possible to make a lip sync error correction using this particular solution. However if the T_{Δ} value is constant, or has a tendency to either increase or decrease over time but within the boundaries of the maximum E threshold, and do that in a linear fashion over time, then the correction is possible using appropriate factor equations. According to one embodiment the factor may change over time if changes in the T_{Δ} value are relatively infrequent, or, in other words, distribution is not too wide around the T_{Δ} value. The lip sync error correction unit 340 provides lip sync corrected audiovisual content 345 thereby overcoming deficiencies that may have occurred in the audiovisual input content 302. It should therefore be understood that the error correction may include, but is not limited to, linear drift correction and non-linear drift correction.

FIG. 4 is an exemplary and non-limiting schematic illustration of a flowchart 400 for detection and correction of lip sync error according to an embodiment. In S410 audiovisual content is received. It may be received from a file or as an audiovisual stream. In the latter case it is necessary to collect or otherwise analyze a sufficient number of video segments and audio segments before an analysis according to the invention can take place. Thereafter corrections and updates can take place as new audiovisual content (for example audiovisual content 302) is provided and an updated analysis takes place that takes into account the newly received content. In S420 video scene cuts in the video content (for example video content 304) of the received audiovisual content are determined, using, for example but not by way of limitation, techniques described herein. In S430 audio scene cuts in the audio content (for example audio content 306) of the received audiovisual content are determined, using, for example but not by way of limitation, techniques described herein. In S440 a comparison analysis is performed to check correlations between the video scene cuts and the audio scene cuts to determine matches as well as T_{Δ} values between video segments and audio segments. It should be understood, as noted with respect of FIG. 2B, that there are cases where there is no one-to-one match between each video segment and each audio segment, and such mismatch, as long as it is infrequent, can be overcome by system 300 by skipping to the next possible match. In S450 it is checked whether the lip sync error is within correctable parameters of the system 300, for example, but not by way of limitation, if T_{Δ} is above E and is inconsistent, as described herein in more detail, and if so execution continues with S470; otherwise, execution continues with S460 where a notification is provided noting that the system, for example system 300, cannot perform lip sync to the received audiovisual content though a lip sync problem does exist, and thereafter execution terminates. In S470 it is checked if the offset between the audio segments and the video segments is smaller than a predetermined threshold, i.e. T_{Δ} is smaller than Δ, and if not execution continues with S490; otherwise, execution continues with S480 where a notification may be generated noting that no lip sync error correction is required. In S490 lip sync error correction is performed so as to compensate for the T_{Δ} between the video segments and the audio segments, for example using techniques discussed herein. The compensation may involve any one of the two cases discussed herein in more detail, i.e., the first case where T_{Δ} is constant, or thereabout, and the second case where T_{Δ} continuously increases or decreases over time. Once correction has completed, execution terminates.

FIG. 5 is a schematic illustration of a second flowchart 500 for detection and correction of lip sync error according to an embodiment and FIG. 6 is a schematic illustration of a third flowchart 600 providing details of the determination of mismatch cost for the second flowchart. Essentially the method starts by obtaining a list of audio and video scene cuts (S505), which may be detected using prior-art solutions, or other solutions which are outside of the scope of the current invention. It then generates a collection start/end audio/video offsets (S510). Each such set points to a specific scene cut (up to a predetermined value X from the list's start) as a possible start, for either list, and to another scene cut (up to X scene cuts from the end of the list) as its end, again from either list. These sets cover all the possibilities for start and end cuts, on either list, resulting in X⁴ such sets. According to the method it will initiate the best found cost to infinity. It thereafter iterates (S520) for each of these possible sets, to determine the A and B factors (S525) for this set, as follows: A_{f}=Vₛ−Aₛ and B_{f}=(Vₑ−Vₛ)/Aₑ−Aₛ). Where Vₛ is the selected video start time of aspecific set; Vₑ the selected video end time; Aₛ the selected audio start time; and, Aₑ the selected Audio end time. Thereafter, a new list of corrected audio scene change times is determined as follows: A[i]=(A[i]−Aₛ)*B_{f}+A_{f}+Aₛ. The method then determines the cost (S530) for this set of A,B factors. The determination is performed (S530) as follows: setting (S530-10) the cost accumulator to 0, the number of detected mismatches to 0, and pointers inside the list for both audio and video, to 0 (Pa=Pv=). Thereafter looping over until both pointers reach the end of their lists, based on the following logic: determining the distance between the pointed-to scene cuts as follows: D=|A[Pₐ]−V[Pᵥ]|. If the pointed to scene cuts are close enough to count as a match (D<=Dₘ), but not a perfect match (D>Dₚ), the distance between them is added to the accumulated cost (S530-20) after which both Pₐ and Pᵥ are increased (S530-25) unless one reached the end of its list, in which case it will not be incremented. In the case where the pointed to scene cuts are close enough to count as a perfect match (D<=Dₚ), both Pₐ and Pᵥ shall be incremented (S530-25) unless one has reached the end of its list, in which case it will not be incremented. In case where the delta is too big (D>Dₘ), the mismatch counter is incremented (S530-30), and then increment the pointer which is pointing to a scene change time that is “further behind” (S530-40 or S530-45 as the case may be), unless that pointer has reached the end of its list, in which case the other one will be incremented. Once both pointers reach the end of their respective lists, the number of mismatches is evaluated (S530-55). If that value is above a predetermined value then the cost of this set is considered to be infinite (S530-60), and it will not be considered a good option. If the number of mismatches is below the predetermined threshold, or equal thereto, then the resulting accumulated cost is the accumulated cost (S530-65) and compared (S535) to the best accumulated cost thus far. If the cost is lower for this set, its cost are saved (S540) as the best cost, and its A,B factors are saved as the best factors thus far. Once all the sets have been evaluated, the following options exist (S550, S560): a. The best cost is still infinity which means that no good match was found, and therefore a notification is provided that lipsync cannot be corrected (S555); b. The best cost is not infinity, the best A factor is 0, and the best B factor is 1 in which case a notification that the lipsync appears to be perfect as-is and no correction is necessary (S565); or, c. The best cost is not infinity, but the best factors differ from A_{f}=0, B_{f}=1 resulting in a notification that the lipsync is not good, but can be corrected by applying these factors to the audio (S570).

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A system for lip synchronization of audiovisual content comprises:
a video cut analyzer adapted to receive a video portion of the audiovisual content and output video segments at video scene cuts;
an audio cut analyzer adapted to receive audio portion of the audiovisual content and output audio segments at audio scene cuts;
a video-audio scene delta analyzer adapted to receive the video segments and the audio segments and determine therefrom at least a time delta value between the video segments and the audio segments and determine at least a correction factor; and
a lip sync error correction unit adapted to receive the video segments, the audio segments and the correction factor and output a lip sync corrected audiovisual content, wherein the correction factor is used to reduce the time delta value of the lip sync corrected audiovisual content to below a predetermined threshold value.

2. The system of claim 1, wherein the video cut analyzer determines a video scene change for the video scene cut based on an abrupt difference between neighboring frames of the video portion.

3. The system of claim 1, wherein the video cut analyzer determines a video scene change for the video scene cut based on a change from a frame in a video scene having a first background to a video scene in a second background.

4. The system of claim 1, wherein the audio cut analyzer determines an audio scene change for the audio scene cut based on a change in an ambient sound.

5. The system of claim 1, wherein the audio cut analyzer determines an audio scene change for the audio scene cut based on a change in an ambient noise.

6. The system of claim 1, wherein the audio cut analyzer determines an audio scene change for the audio scene cut by performing a spectro-temporal filtering.

7. The system of claim 1, wherein the lip sync error correction unit provides a notification that lip sync correction cannot be performed upon determination that the lip sync error is not within correctable parameters.

8. The system of claim 1, wherein the lip sync error correction unit provides a notification that lip sync correction is unnecessary as the lip sync error is smaller than a predetermined threshold value between audio and video.

9. The system of claim 1, wherein the lip sync error correction unit performs the lip sync error correction upon determination that the lip sync error is within correctable parameters but above a predetermined threshold value for the offset between audio and video.

10. The system of claim 1, wherein the audiovisual content is at least one of: video clip file, streamed video content, and broadcast video content.

11. The system of claim 1, wherein the error correction unit is further adapted to perform at least one of: a linear drift correction and a non-liner drift correction.

12. A method for lip synchronization of audiovisual content comprises:
receive audiovisual content that require lip sync;
detecting all video scene cuts in the received video content of the audiovisual content;
detecting all audio scene cuts in the received audio content of the audiovisual content;
performing a comparison analysis between video cuts and audio cuts to determine a sync error;
generating a notification that a lip sync is required for the audiovisual content but cannot be performed upon determination that the sync error is not within correctable parameters;
generating a notification that no lip sync is required for the audiovisual content upon determination that the lip sync error is within correctable parameters and that an offset between the video content and the audio content is below a predetermined threshold value; and
performing a lip sync error correction to reduce the lip sync error between the video content and the audio content upon determination that the lip sync error is within correctable parameters and that the offset between the video content and the audio content exceeds the predetermined threshold value.

13. The method of claim 12, wherein a detection of a video scene cut comprises:
determining an abrupt difference between neighboring frames of the video content.

14. The method of claim 12, wherein a detection of a video scene cut comprises:
determining a change from a frame in a video scene having a first background to a video scene in a second background.

15. The method of claim 12, wherein a detection of an audio scene cut comprises:
determining a change for the audio scene cut based on a change in an ambient sound.

16. The method of claim 12, wherein a detection of an audio scene cut comprises:
determining a change for the audio scene cut by performing a spectro-temporal filtering.

17. The method of claim 12, wherein performing a lip sync error correction comprises performing at least one of: a linear drift correction and a non-liner drift correction.
